(19) United States
(12) Patent Application Publication
(10) Pub. No.: US 2014/0321026 A1
(43) Pub. Date: Oct. 30, 2014

(54) LAYER SYSTEM HAVING A LAYER OF CARBON NANOTUBES ARRANGED PARALLEL TO ONE ANOTHER AND AN ELECTRICALLY CONDUCTIVE SURFACE LAYER, METHOD FOR PRODUCING THE LAYER SYSTEM, AND USE OF THE LAYER SYSTEM IN MICROSYSTEM TECHNOLOGY

(71) Applicants: Sascha Hermann, Chemnitz (DE); Thomas Gessner, Chemnitz (DE); Stefan E. Schulz, Chemnitz (DE)

(72) Inventors: Sascha Hermann, Chemnitz (DE); Thomas Gessner, Chemnitz (DE); Stefan E. Schulz, Chemnitz (DE)

(73) Assignees: Fraunhofer-Gesellschaft zur Foerderung der angerwandten Forschung e.V., Muenchen (DE); TECHNISCHE UNIVERSITAT CHEMNITZ, Chemnitz (DE)

(21) Appl. No.: 14/131,318

(22) PCT Filed: Jul. 6, 2012
(86) PCT No.: PCT/EP2012/063280

§ 371 Date: May 23, 2014

(30) Foreign Application Priority Data
Jul. 8, 2011 (DE) 102011051705.7

(51) Int. Cl. C01B 31/02; H01G 2/08; H01G 11/36

(52) U.S. Cl. CPC C01B 31/0233; H01G 11/36; H01G 2/08
USPC 361/502; 427/249.1; 428/323

(57) ABSTRACT

The present invention relates to a coating system comprising a layer of carbon nanotubes aligned parallel to another, and a directly linked surface layer with metallic properties, from which said carbon nanotubes are grown in “tip” growth. The coating system may further comprise a base layer and/or a substrate. It can be obtained by producing a structured layer from a first phase, consisting of a metal having no independent catalytic activity in terms of the emergence of CNTs from the gas phase, and a second phase consisting of a metal, which catalyzes the emergence of CNTs from the gas phase, on a substrate or a base layer, wherein the first phase has an uneven thickness and/or folded structure potentially interspersed with pores, and the second phase is located in depressions and/or pores of the initial phase in such a way that both material phases are present at least partially next to each other in the lateral plane on said substrate or said base layer located thereon. Carbon is removed from a hydrocarbon gas atmosphere on this structured layer, wherein carbon nanotubes form, which raise at least parts of the structured layer in closed form. The substrate or base layer may then be removed. The coating system of the invention is suitable for use in a variety of components and electronic micro and nanosystems, flip chip connections, sensors and actuators, particularly pressure sensors, touch sensors, optical sensors, reflectors, projectors, optical filters, nanopositioning systems or interferometers in a specific form in a supercapacitor.

The present invention relates to a coating system with a layer comprised of carbon nanotubes (CNTs) aligned parallel or largely parallel to each other and a surface layer with metallic properties, which is in electrically and thermally conductive contact with the CNTs. Furthermore, the coating system may have a base layer and/or a substrate, which may have metallic or dielectric properties. The coating system can be produced by means of a catalyst layer on a base layer and/or a substrate, which, aside from a catalyst known for the growth of CNTs, has a structuring material.

Due to their special properties, carbon nanotubes offer potential for use in a variety of applications. Noteworthy is the one-dimensional structure with high aspect ratios, structurally-dependent physical properties, ballistic electron transport, thermal conductivity (up to 6000 W/m K) as well as extreme mechanical properties. CNTs can be produced with various methods, such a laser ablation, arc discharge, or chemical vapor deposition (CVD). Moreover, prefabricated CNTs can be deposed with various methods, such as spin-on, ink jet, or dielectrophoresis. In the case of the latter methods, possibilities for integration are limited because, first, we are limited to a horizontal arrangement of CNTs, and second, various chemicals are necessary, which have a partially disturbing effect on the application. Thus, for many applications, direct growth of CNTs in the application-relevant structures is necessary, wherein both horizontal as well as vertical arrangements are possible. In this connection, the CVD or the plasma-enhanced CVD (PECVD) emerged due to moderate growth temperatures and selectivity. In the process, CNTs grow from catalysts, such as metals from the iron family (Ni, Co, Fe), palladium or binary systems, such as Co—Mo, Pd—Se, Fe—Ni or Ni—Cu. A catalytic decomposition of a carbonaceous precursor occurs at temperatures in the range of 300 to 900° C. Despite great progress with the CVD methods, there are still great difficulties integrating CNTs in electronic and sensory components. Noteworthy in this context is the porosity due to the limited density of CNTs. In general, the filling ratio is significantly smaller than the highest level of packing density (Dijon, J.; Fournier, A.; Szkutnik, P. D.; Okuno, H.; Jayet, C.; Fayolle, M.: “Carbon nanotubes for interconnects in future integrated circuits: The challenge of the density” Diamond and Related Materials, vol. 19(5-6), pp. 382-388, 2010). Previously, through special process control, a filling ratio of no more 40% was able to be achieved Yamazaki, Y.; Katagiri, M.; Sakuma, N.; Suzuki, M.; Sato, S.; Nihei, M.; Wada, M.; Matsunaga, N. et al: “Synthesis of a Closely Packed Carbon Nanotube Forest by a Multi-Step Growth Method Using Plasma-Based Chemical Vapor Deposition” Appl Phys Express, vol. 3(5), pp. 055002, 2010. This led to a variety of fundamentally as well as technologically challenging problems. First, vertically grown CNTs must have proper contact on the upper end as well for electrical/thermal applications. On the one hand, a simple integration with one metal would result in an interdiffusion of the materials due to the low density. On the other hand, this does not produce good contact as the shells are generally closed. Thus, this only provides a contact to the outermost shell. There are developments that open the ends of the CNT with the aid of chemical mechanical polishing (CMP). However, this requires a mechanical stabilization with additional process steps, such as the incorporation of a filler (dielectric) and the CMP (e.g. Yokoyama, D.; Iwasaki, T.; Ishimaru, K.; Sato, S.; Hyakushima, T.; Nihei, M.; Awano, Y.; Kawarada, H.: “Electrical properties of carbon nanotubes grown at a low temperature for use as interconnects” Jpn J Appl Phys, vol. 47(4 PART 1), pp. 1985-1990, 2008). This method is only conditionally appropriate for ULSI (ultra-large scale integrated) applications because the homogenous and complete filling of spaces in the nanometer range between nanostructures with high aspect ratios has not been achieved to date. Embeddings remain, which can lead to serious reliability problems when used. For other applications, it is necessary to produce a layer with vertical CNTs that have no spatial filling, but still have proper electrical/thermal contacts at the ends of the CNTs. Previous methods are not suitable for this case, as an interdiffusion of the contact material and the CNTs is always expected and the contacts are not capable of being optimal. Moreover, the fact that the length of the CNTs is not uniform is problematic for many applications. It is subject to heavy fluctuations, such that stabilization and planarization via CMP is therefore necessary.

There are likewise great technological challenges in sensory applications that build on CNTs and their special properties. The field emission may be used for detecting the smallest movements triggered by deformation (deflection, pressure) or movement/acceleration (translation, rotation, vibration). This is particularly severe in the case of CNTs due to the diameter of a few nanometers, and it allows for applications, e.g. field emission displays. This effect is likewise suited for the detection of movement (Liu, P.; Dong, L.; Arai, F.; Fukuda, T.: “Nanotube multi-functional nanoposition sensors” Proceedings of the Institution of Mechanical Engineers, Part N: Journal of Nanoengineering and Nanosystems, vol. 219(1), pp. 23-27, 2005). Dense and vertical CNTs, which have good electrical contact to the electrode on one side and an electrode at a defined distance on the opposite side, are necessary for an efficient implementation of this movement detection principle. The CVD method is predestined for producing such CNT coatings or CNT arrays. However, if we consider the use of CVTs that were produced in “tip” or “root” growth in CVD processes, a strong variation of length, as it generally exists, should lead to serious integration problems and limitations in component performance. Thus, for example, the variation of length requires a sufficiently large distance between the end of the CNT and the counter electrode, which consequently substantially increases the operating voltage. Furthermore, the application of a counter electrode is tied to a certain effort, which under certain conditions could complicate the implementation of low-cost components. Therefore, there are still generally serious technological problems with the integration of CNTs in sensors, interconnects or actuators. Even new and complex nanosystems comprised of various nanocomponents, which are selectively equipped with specific physical properties, are difficult to implement using previous approaches.

Several publications deal with the manufacturing of CNTs that grow out vertically from a subsurface. This type of growth is designated as “root” growth. There are some references to chromium-containing carrier/catalyst systems in literature, which may be used for the growth of CNTs. In their article, “Vertically aligned carbon nanotube growth by pulsed laser deposition and thermal chemical vapor deposition methods” Applied Surface Science, vol. 197-198, pp. 568-573, 2002, Sohn, J. I.; Nam, C.; Lee, S. used chromium in addition to silicon, SiO₂ and other nonconductors as carriers for iron nanoparticles as catalysts. However, compared to a substrate consisting of, e.g. Si, a chromium substrate proved to be inferior. In “Enhancement of electron field emission from carbon nanofiber bundles separately grown on Ni catalyst in Ni—Cr alloy” Carbon, vol. 47(5), pp. 1258-1263, 2009, Shimoi, N. and Tanaka, S. i. describe the growth of CNTs on nickel as catalysts. If the layer, out of which the CNTs grew, was comprised of a nickel-chromium alloy with 57% nickel, which was obtained by co-sputtering nickel pellets on a chromium plate, separate areas comprised of nickel would emerge, on which clusters of CNTs would grew, while no CNTs would grow in the intermediate areas comprised of chromium. In this way, CNTs clusters with controlled distances could be produced in between. The tips of the individual CNTs would contain nickel. There are opposing views regarding to the role of chromium in the production of CNTs with the aid of CVD methods. Thus, Park, Y. J.; Han, I. T.; Kim, H. J.; Woo, Y. S.; Lee, N. S.; Jin, Y. W.; Jung, J. E.; Choi, J. H. et al. used a catalytic layer of a Ni/Fe/Co alloy and found that no CNTs grew on this alloy if a chromium layer was present below, which served as a cathode. Chromium infused in the alloy lowered the catalytic activity (see “Effect of Catalytic Layer Thickness on Growth and Field Emission Characteristics of Carbon Nanotubes Synthesized at Low Temperatures Using Thermal Chemical Vapor Deposition” Jpn J Appl Phys, vol. 41(Part 1, No. 7A), pp. 4679, 2002). Similar observations were made by Yoo, H. S.; Park, C. H.; Yun, S. J.; Joo, S. K.; Hwang, N. M.: “Effect of Base Layers beneath Ni Catalyst on the Growth of Carbon Nanofibers Using Plasma-Enhanced Chemical Vapor Deposition” Jpn J Appl Phys, vol. 47(4), pp. 2306, 2008. Another group was able to produce multi-wall CNTs (MWNTs) on a multilayer catalyst, for which Al with a thickness of 10 nm, Cr with a thickness of 2 nm, and Co with a thickness of 2 nm was sputtered on a substrate (Cheng, H. C.; Lin, K. C.; Tai, H. C.; Juan, C. P.; Lai, R. L.; Liu, Y. S.; Chen, H. W.; Syu, Y. Y.: “Growth and Field Emission Characteristics of Carbon Nanotubes Using Co/Cr/Al Multilayer Catalyst” Jpn J Appl Phys, vol. 46(7A), pp. 4359, 2007). Lee, C. J.; Park, J.; Kim, J. M.; Huh, Y.; Lee, J. Y.; No, K. S. describe the use of Co—Ni particles as nucleating source for the growth of CNTs, wherein Pd, Cr or Pt were selected as Co catalysts in order to lower the growth temperature. However, the SEM images do not show any aligned, parallel, orthogonal growth of the CNTs. According to more recent experience, the catalysts for the synthesis of CNTs can be categorized in three classes:
1. Ideal catalysts are metals with few faults in the d orbital, which have a certain solubility of carbon, but simultaneously have less of a tendency to form carbide. These are, for example, Co, Ni, Fe (see Esconjauregui, Santiago, Whelan, Caroline M., and Maex, Karen: “The reasons why metals catalyze the nucleation and growth of carbon nanotubes and other carbon nanomorphologies” Carbon, vol. 47(3), pp. 659-669, 2009)
2. Poor catalysts are metals with many faults in the d orbital, which have a strong tendency to form carbide, e.g. Ti or Ta, see Esconjauregui et al., at the specified location
3. Other metals, which have no faults in the d orbital, have no solubility of carbon and generally do not demonstrate any CNT growth (e.g. Cu, Ag, Au), see S. Esconjauregui et al., at the specified location. However, as soon as catalytic nanoparticles with a very small diameter are present (<˜3 nm), surface effects dominate and several metals, which would otherwise not be suitable, may affect CNT growth (see Takagi, D.; Homma, Y.; Hibino, H.; Suzuki, S.; Kobayashi, Y.: “Single-Walled Carbon Nanotube Growth from Highly Activated Metal Nanoparticles” Nano Lett, vol. 6(12), pp. 2642-2645, 2006). In the case of sufficiently small catalytic nanoparticles, the catalysis of CNTs is observed even with non-metallic nanoparticles, e.g. SiO₂ nanoparticles., see Liu, B.; Ren, W.; Gao, L.; Li, S.; Pei, S.; Liu, C.; Jiang, C.; Cheng, H. M.: “Metal-Catalyst-Free Growth of Single-Walled Carbon Nanotubes” Journal of the American Chemical Society, vol. 131(6), pp. 2082-2083, 2009.

US 20080131352 A1 describes the manufacturing of CNTs growing out vertically from a base, the tips of which are interconnected through a surface layer. This is comprised of a carbon network. In a publication of the workgroup of the inventor, Kondo, D.; Sato, S.; Awano, Y.: “Self-organization of Novel Carbon Composite Structure: Graphene Multilayers Combined Perpendicularly with Aligned Carbon Nanotubes” Appl Phys Express, vol. 1(7), pp. 074003, both the manufacturing methods as well as the product are described in more detail—a TiN layer of 5 nm was separated on a silicon substrate with a 300 nm thick SiO₂ layer. As a catalyst, a cobalt layer was applied thereon, which was between 2.1 and 3.6 nm thick according to this printed publication, while US 2008/0131352 A1 identifies an upper boundary of 2 nm for the Ni layer. A CVD of carbon through the use of a gas mixture comprised of acetylene and argon in a ratio of 1:9 resulted in the growth of CNTs, the tips of which are interconnected through a graphite or graphene layer, the network levels of which are aligned vertically with the walls (the walls of the CNTs) located below. Catalytic particles are embedded in the surface layer, which has also already been previously found in the tips of the CNTs grown on catalysts. The authors assume that first a graphene multilayer will deposit during the course of formation of this structure. Subsequently, the cobalt, which was previously layer-shaped, would convert to particles. This would result in MWNT clusters developing through “tip growth”, i.e. growth from the tip down, through which the graphene layer and the cobalt particles would be lifted up. Due to the fact that the growth of CNTs was observed with a cobalt layer having a thickness of only 1 nm, though without a graphene layer, the authors assume that it would be essential that the catalyst would have to be prevented from forming particles at the onset of the growth process.

This structure was recommended for the manufacturing of via interconnects and as a thermal conductive layer. The production of CNT vias was able to be demonstrated specifically in US 2008/0131352 A1. Because graphite and graphene have strong anisotropic physical properties, it is necessary to assume that there is only poor electrical/thermal conductivity (compared to lateral conductivity) vertical to the graphite or the graphene layers; this has been confirmed at least for the electrical conductivity through the measurement of resistance with a via of a diameter of 2 μm. In this case, the resistance was 13Ω. Although this may allow us to conclude that the tips of the CNTs are physically connected with the graphene layer, if we take known CNT densities from literature, the resistance is yet even greater than theoretically possible (approx. 10 times too high). Such a resistance, therefore, is nowhere near sufficient to be able to assume a real electrical contact between the CNTs and the surface layer, or even to use for applications. Furthermore, the resistance is approx. 1000 times higher than in a comparable copper via, which may possibly be justified with a CNT density that is too low. A subsequently applied metal conductor, as is necessary in the manufacturing of CNT/metal hybrid conductor systems, should accordingly not be allowed to come into optimal contact with the CNTs.

According to WO2010/087903 A1, for example, a carbonaceous substrate is first occupied with a catalyst layer (normally a discontinual layer) and then with an insulating layer, e.g. comprised of Al₂O₃. If the coated substrate is heated in a reducing atmosphere to active the catalyst, the insulting layer breaks into individual parts, through which the catalyst is exposed to the reducing atmosphere. In reaction to this, the carbon nanotubes grow between the substrate and the broken insulating layer 103. In the process, they raise the broken insulating pieces, which take the catalyst with them.

In “Current Applied Physics” 10, 407-410 (2010), A. Matur et al. describes the use of an ultrathin iron layer as a catalyst for the growth of carbon nanotubes. Upon heating, island-shaped catalyst structures formed (see FIG. 3). In “Thin Solid Films” 471, 140-144 (2005), Chih Ming Hsu et al. examined the growth of CNTs on silicon wafers, which had either a barrier layer comprised of titanium or a silicon dioxide layer in combination with cobalt as a catalyst. With the use of silicon dioxide, a tip growth of the CNTs was observed, wherein, in conclusion, the CNTs were covered with a thin surface layer, in which nanoparticles were embedded. The structure at the ends of the CNTs was comprised of a carbon film that was surrounded by catalytic particles.

The printed publications, US 2002/0163079 A1 and U.S. Pat. No. 7,094,692 B2, deal with CNTs that are suitable as vias or conductors. According to US 2002/0163079 A1, cobalt, nickel or iron is used as a catalyst; after the growth of the carbon nanotubes, the catalyst can be found at the end of the nanotubes, i.e. at the tip, insofar as we are dealing with tip growth. In the process, the catalyst here was located within each individual nanotube, the end of which was closed with a carbon structure (see Section[77]). According to U.S. Pat. No. 7,094,692 B1, nickel, iron, cobalt, or palladium is used as a catalyst; the catalyst layer aggregates in a particulate manner, and the carbon nanotubes grow, wherein the catalyst particles prove to be nuclei of growth. In the case of tip growth, the catalyst is found accordingly attached to the tips of the individual carbon nanotubes in a particulate manner.

US 2008/0131352 A1 also deals with conductive structures that are developed from carbon nanotubes. According to Example 1, a particulate catalyst is arranged between the CNT parts and their end parts, which are likewise comprised of carbon.

The task of the present invention is to provide a structure comprised of a surface layer with CNTs located below, which at least partially prevents the disadvantages of the state of the art due to the fact that a thermal and electrical contact exists between the CNTs and the surface layer, such that a thermal and electrical contact to the base of the CNTs exists by means of electrical contact of the surface layer. Vertical conductor connections as well as other, primarily micro and nanoelectronic applications should be implemented with such a structure.

The task is solved through the provisioning of a coating system comprising a layer consisting of carbon nanotubes aligned parallel to each other and a surface layer with metallic properties thereupon.

Surprisingly, this coating system could be obtained through the use of a catalyst layer that differs from previous catalysts through the presence of a structuring material, which is explained in greater detail below.

The surface layer is comprised at least in large parts and preferably completely of material from the used structuring material, namely a metal that itself does not independently act as a catalyst, particularly chromium with the particles of the used catalyst system, particularly nickel or cobalt, embedded or alloyed therein. Therefore, it possesses metallic properties both with regard to electrical as well as thermal conductivity. It acts as a protective layer, which, on one hand, allows for the execution of various wet-chemical etching processes. On the other hand, plasma-based dry-chemical as well as physical etching processes are possible without exposing the CNTs to a direct ion bombardment, which is hardly feasible with a carbon-based, significantly more sensitive surface layer. Such resistance is, e.g. in Damascene processes such as are necessary for manufacturing complex circuits, of great technological benefit. In this context, said surface layer can, e.g. also be used as an etch stop. Said layer is preferably completely closed. Because said surface layer is in direct contact with the tips of CNTs, as their tips protrude into them, there is also positive mechanical stability. Due to the physical connection of CNTs with the surface layer, said CNTs are electrically and thermally connected with them as well as among each other.

The coating system may have a base layer and/or a substrate, e.g. a metallic layer or a non-metallic, insulting layer, e.g. comprised of silicon, silicon dioxide, and tantalum nitride or similar. Said base layer and surface layer are generally essentially parallel to another, although they may also include an angle between them if the length of said CNTs changes controllably beyond the plane of said base layer or substrate (increases or decreases).

The alignment of CNTs is primarily given through the position of the subsurface. Normally, CNTs grow vertically from the layer located below or above; in the case of a neat subsurface structure and selective covering with catalysts, it is possible to obtain CNTs seemingly growing angularly to the main axis of said substrate.

Because the coating system according to the invention is manufactured beginning with a coating containing a catalyst on said base layer or substrate, this is principally present initially; however, if necessary, it can potentially be removed, e.g. through etching.

The density of CNTs is high; depending on the compilation of said coating system (layer thicknesses) and diameter of CNTs, it is preferably in the range of 5×10⁹ to 5×10¹²/cm².

The invention will be explained in further detail through the attached figures, wherein

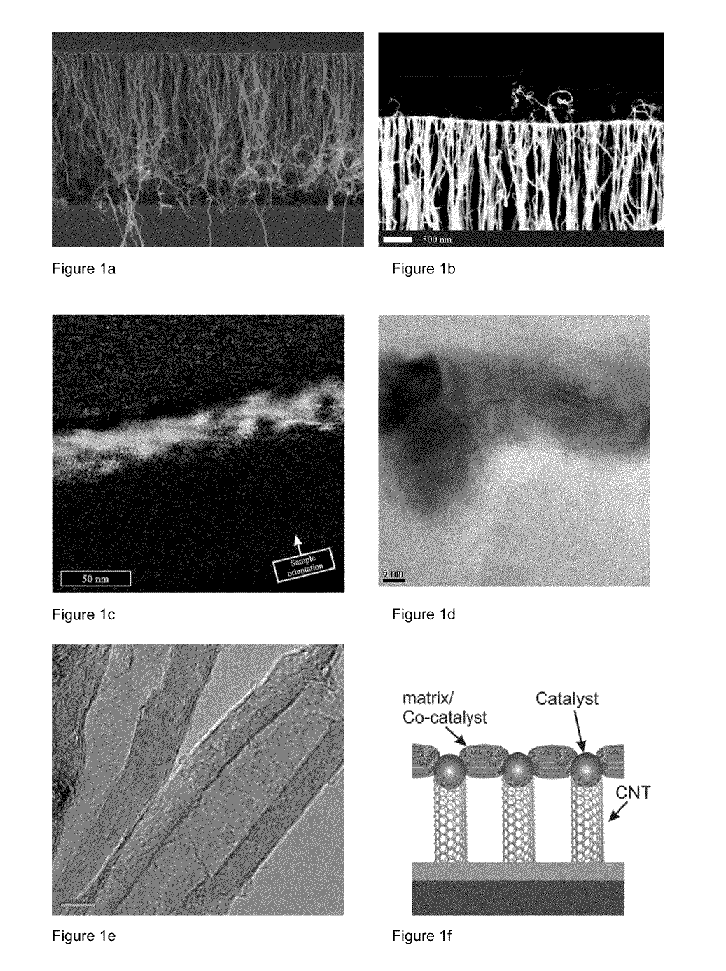

FIG. 1 shows the layer structure of ICNT nanostructure with a substrate on the bottom side, vertically aligned CNTs thereon, and a thin and closed Cr/Ni or Cr/Co layer on the top side: (FIG. 1a); FIG. 1b shows an enlargement of the top side; FIG. 1c shows a TEM image of multi-walled CNTs; FIG. 1d is a TEM cross-section of said Cr/Ni layer; FIG. 1e is a TEM cross-section in EELS mode of said Cr/Ni layer and shows the distribution of elements (Cr—the bright center strips and Ni—the upper, slightly “dotted” appearing area); FIG. 1f is a postulated growth model;

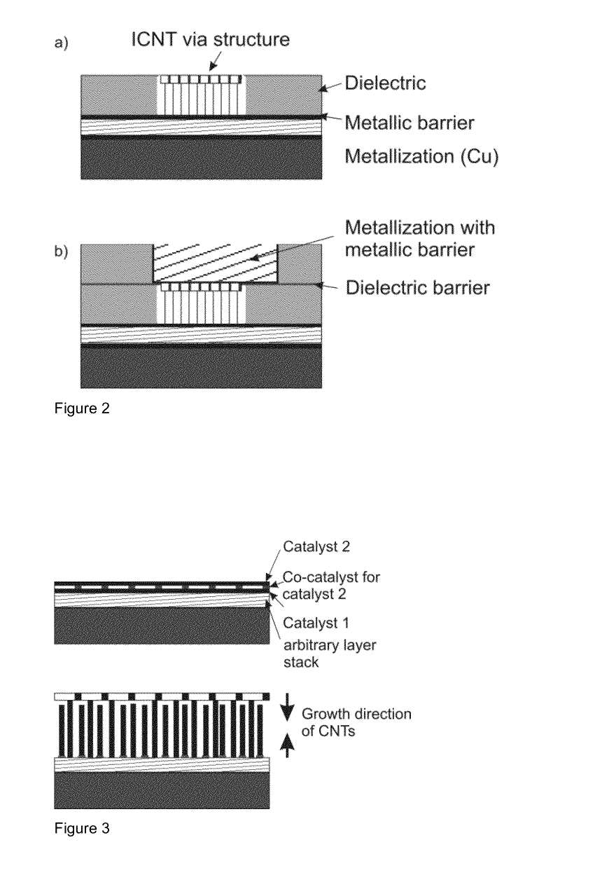

FIG. 2 depicts the structured growth of ICNTs in via holes with precise adjustment of the CNT height (a) and formation of the next conductor plane (b);

FIG. 3 depicts a multilayer catalyst system for the production of CNTs growing in each other;

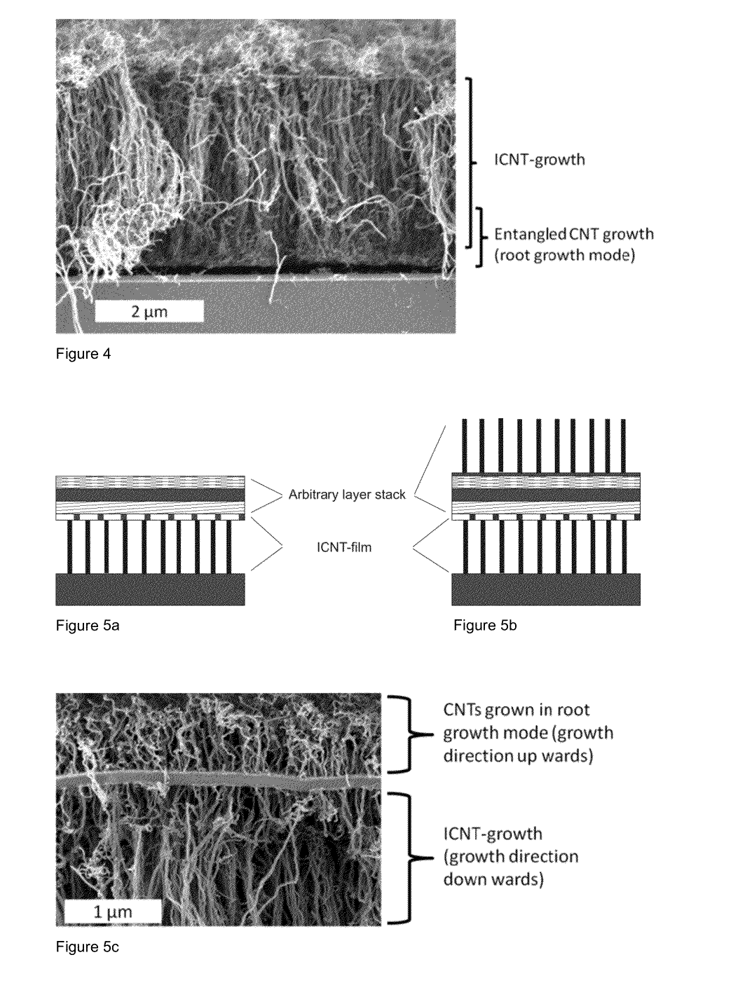

FIG. 4 depicts the SEM cross-section of two CNT layers growing in each other, produced with a Si/SiO₂Ni/Cr/Ni structure, based on first attempts; the quality of the layers can still be significantly improved through the appropriate variation of the process conditions used;

FIG. 5 depicts examples for nanostructures that can be produced on the basis of said ICNT layer; said ICNT layer with layer stack (b), respectively depicted schematically. In the REM cross-section image from the first attempts (c), (the quality of the layers can still be significantly improved through the appropriate variation of the process conditions used) the individual structures can be clearly recognized;

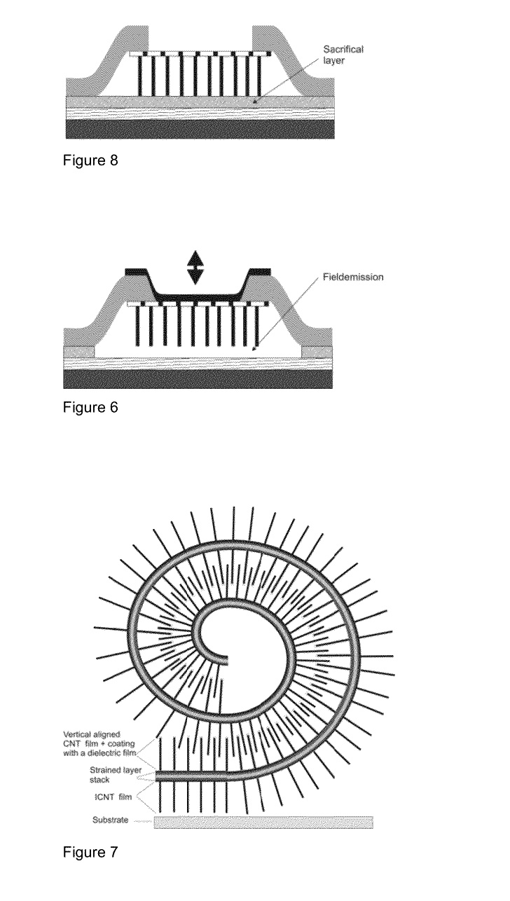

FIG. 6 shows an example of the embodiment in the forms of a pressure sensor based on the ICNT structure, which enables a pressure measurement via field emission regardless of the type of gas.

FIG. 7 shows a supercapacitor that is realized by a layer stack comprised of an ICNT layer, two metallization layers insulting from each other, stress layers (e.g. Al₂O₃ and SiO₂) and an additional layer of CNTs. Coiling is affected through exposure of said layer stack and the release of the layer stack according to the state of the art.

The coating system pursuant to the invention is produced with the aid of a specially structured catalyst system. Said catalyst system is applied to the base layer or substrate and completely raised from its surface during the manufacturing process and supported by the CNTs. On the basis of the resulting structure, primarily new and improved integration methods of CNTs in electronic and sensory applications arise. This includes the realization of CNT conductors in ULSI circuits, heat dissipation structures for all high-performance components, mechanically functional layers, supercapacitors, optical sensors, electromechanical sensors, spin-electronics and actuators.

For the first time, the inventors were able to develop a new nanostructure, in which vertically growing carbon nanotubes jointly lift a completely metallic coating system from the substrate in a thermal CVD process. The special feature is that this coating system, as a generally closed and very smooth layer, is supported by CNTs (see 1a and b). The layer on the CNTs has a low level of roughness, such that it appears shiny metallic. The roughness was determined to be <5 nm (RMS). This differs significantly from the typical matt black appearance of CNT layers. The type of growth can be subordinated to the “tip” growth mode. Due to the layer structure, this special growth is defined as interlayer growth of CNTs (interlayer growth; CNTs). Structural analyses of the layer that were conducted with the catalyst systems, Ni or Co, and the structuring material, chromium, indicate a phase separation between both components, which remains intact from the pretreatment of the catalyst to the end of CNT growth (see FIG. 1 c and d). The CNTs grow in the form of potentially single-wall, generally multi-walled, CNTs (MWCNTs or MWNTs) from the bottom out (see FIG. 1e). On the basis of extensive analyses, a layer structure was derived, which is schematically depicted in FIG. 1f. The CNTs are characterized by high quality (low defect rate), an essentially vertical alignment, and long segments with a very well pronounced shell structure, which is also expressed in particularly straight CNTs. Furthermore, only slight metallic embeddings are present in the CNTs. Compared to CNTs that were produced in “root” growth, the ICNTs of the present invention have a smaller defect density—in direct comparison to a reference process, in which “normal” CNTs grew on a Si/SiO₂(100 nm)/Ta(10 nm)/Ni(2.1 nm), a low defense density of up to 30% was determined (measured with the DG ratio of peak intensity with the Raman spectrum).

Although the inventors do not wish to be tied to a theoretical explanation of the growth processes, reference is made to the fact that the structure of the CNTs can be linked to the special type of the growth. On one hand, the ICNT structure enables a dispensed supply of carbon via the catalyst. On the other hand, the growth conditions during the growth process are nearly constant. The latter is particularly beneficial for the growth of long and dense CNT layers, as the diffusion of gas depending on the thickness of the layers and structure is not relevant at that point. Furthermore, the structuring material may play an important role. This is another special feature of this nanostructure. Normally, catalyst systems with co-catalysts affect “root” growth. This requires costly coating systems that also remain on the substrate and, thus, under certain conditions negatively affect latter application (e.g. increasing the electrical resistance). In contrast, the present catalyst system is completely lifted from the surface of the substrate by the growth of the CNTs. A subsequent removal of the substrate from the CNT layer is, therefore, possible without difficulty (e.g. through etching or CMP).

Pursuant to the invention, silicon may be used as a substrate for the coating system. Any other electrically conductive or insulating substrate may be used in its place. A smooth surface is beneficial. If necessary, an insulating or conductive layer can be applied to the substrate as a base layer, which e.g. may offer improved temperature stability or even a latter connection. As such, the thickness of the layers is not an issue. It may be, e.g. between 20 nm and 2 μm, preferably between 50 and 250 nm thick. This layer can be produced, e.g. through thermal oxidation of the substrate (SiO₂) or applied with a CVD or PVD method. The material of this layer may be an oxide of the substrate material, e.g. SiO₂. SiO₂ provides itself, e.g. as a sacrificial layer if the coating system pursuant to the invention is designed not to have a base layer at a latter point because it can be etched away. Alternatives are electrically conductive and temperature-stabile layers consisting of TiN, TaN, Ti, Ta, Pd, W or similar, which, e.g. can be used as a component for the realization of conductors, for example, in the form of vias. Naturally, the substrate itself can be structured or provided with doping. If there is a base layer, any additional layers may be present below the base layer, which a specialist is capable of selecting based on the intended use of the coating system pursuant to the invention according to the state of the art.

A structured layer is formed on this subsurface, regardless of whether it is the substrate or base layer. For this purpose, a structuring material has to be formed in a layer form together with a catalyst material, wherein the two material phases are present in the lateral plane on the substrate at least partially side by side.

The structured layer comprises or consists of a first phase, consisting of a metal having no independent catalytic activity in terms of the emergence of CNTs from the gas phase and a second phase consisting of a metal, which catalyses the formation of CNTs from the gas phase. As mentioned above, cobalt or nickel may serve as catalysts, though iron or an alloy of these materials can be used instead, or other materials, the suitability of which for the formation of CNTs in gas deposition processes is known. In this context, please refer to the above cited publications of S. Esconjauregui et al., D. Takagi et al. and B. Liu et al. As an example, ruthenium, silver and gold are mentioned, wherein silver and gold particles only act catalytically if they are very small because their catalytic effect is an effect of special physical/chemical properties with nanoparticles having an extremely small diameter. The material of the first phase will now be referred to as structuring material; in the structured layer it has a non-uniform thickness and/or folded structure, potentially interspersed with pores, while the second phase is located in recesses and/or pores of the first phase such that both material phases are present at least partially next to each other in the lateral plane.

To produce this structured layer, a layer consisting of the metal is applied as a structuring material onto the first subsurface layer, which, in the applied form, may not have a separate catalyst function for the formation of CNTs. It must be ensured that the material serves as a seed for the growth of CNTs. It potentially has a co-catalytic effect. This means that this material reduces the activation energy required for the release of carbon in the solid interface, but without being able to catalyze the growth of CNTs independently. However, the inventors assume that in particular the structure, which takes this material due to subsequent process steps, is important, possibly as a stabilizing matrix. This material, for example, is applied by means of PVD; alternative techniques such as electron beam deposition or atomic layer deposition (ALD) are possible. The layer thickness should generally be in the nm range and is preferably selected between approx. 3 to 15 nm, more preferably between approx. 5 or 6 and 15 nm. At least with chromium as a structuring material, the inventors have namely found that if the layer thickness is substantially less than 3 nm, “normal” CNT growth can be observed. They have also observed that if the layer thickness is substantially greater than 15 nm, no CNTs are formed.

Which metal or which alloy can be used also depends on the catalyst. Permitted combinations may be derived, e.g. from the phase diagram. Under the condition of using nickel and/or cobalt as a catalyst is an example of a usable structuring material, chromium; however, molybdenum or ruthenium, or alloys, for example, containing one or consisting of two or all three of these metals are respectively all in question, thus, for example, the combinations Co/Mo, Ni/Mo, Fe/Mo, Co/Ru, Ni/Ru or Fe/Ru. For the use of other catalysts known from the state of the art, such as those listed in the introduction, other materials suitable as structuring material can be derived from the phase diagram. Preferably, the criterion should be met that with the combined materials, there is a phase separation or one is adjusted during the sample pretreatment. Accordingly, it is unlikely that in the case of metals that completely alloy at the process temperatures used in the invention, ICNT growth can be observed.

On one hand, the structured layer can be formed from a stacked coating system. In this regard, a thin catalyst layer is applied to the layer applied flat consisting of structuring material. This layer may be deposited like the structuring layer through sputtering, electron beam evaporation or ALD. The thickness of the layer should preferably be selected in the range of 1 to 5 nm. A subsequent treatment at temperatures above approx. 300° C. in an H₂-containing atmosphere (hereinafter referred to as “thermal treatment”) leads to an agglomeration of the two layers. AFM investigations of systems with a chromium layer as a structuring layer demonstrated a wrinkle-like rupture of the layer. The resulting “troughs” serve as storage sites for nanoparticles from the catalyst material. A similar layer structure can also be affected by nanostructuring or by self-configuration of nanoparticles.

The catalyst particles in this layer structure should have adequate mechanical connection with the surrounding (structuring) matrix.

Through the appropriate selection of process conditions (layer composition, pretreatment, gas composition and temperature), the layer structure pursuant to the invention can then be produced in a thermal CVD process. The composition and structure of the catalytic layer required for the emergence of the layered composite pursuant to the invention was described above. A pretreatment of the sample at high temperatures in an inert or reducing atmosphere, for example, at about 500-700° C. in N₂/H₂ atmosphere is beneficial. The production of CNTs should preferably occur in the same reactor and directly subsequently if possible. A carbonaceous gas, such as methane, ethylene or acetylene, which is potentially diluted with an inert gas, serves as the source for the carbon of the CNT. In the present case, ethylene was typically used as a carbon source, preferably in a combination with H₂ and diluted with nitrogen. Growth temperatures in the range 570-660° C. lead to good results, but the ICNTs can also be obtained at much lower temperatures. By adjusting the process time, the thickness of the CNT layer can be adjusted with high precision. This was able to be demonstrated experimentally in a range between 1 and 5000 nm. We can expect that, for example, with an extension of the treatment time and/or a partial pressure greater than that used in previous production processes, the thickness of the CNT layer can be further increased. After completion of the step, in which the intermediate CNT layer is formed, a closed metal layer can be found therein as a surface layer. EDX cross-sectional studies demonstrate an almost complete removal of Cr/Ni from the base layer in the specific case of the use of the combination of chromium/nickel.

The closed metallic surface layer of the CNT layer in the layered compound produced in this manner allows for the development of various coating systems on said CNTs, which open new technologies and application possibilities. As such, one or more additional layers can be removed, e.g. on the ICNT layer. Possible applications are:
Simplification and improvement of the technology for the production of CNT vias in ULSI circuits
Generation of super-dense CNT layers through multi-directional CNT growth for interconnect applications, thermal dissipation layers, layers with higher mechanical strength
The ICNT structure allows new possibilities of integrating CNTs in electronic nanosystems
ICNT layers with different additional functional layers can be used for various sensors, such as pressure and touch sensors or optical sensors.
Simple realization of microphones with extended frequency range and high sensitivity
Simple realization of nano-columns with larger areas, through subsequent oxidation of the CNTs
Construction of adjustable optical filters with simple technology
Actuators in the form of MEMS or NEMS (nano-electromechanical systems) with high precision
Generation of new nanostructures with stacked CNT layers that can be applied for the production of supercapacitors

A particularly preferred application of the present invention is in the transfer of vertical CNTs to desired substrates, which is possible as the result of the specific ICNT structure of the invention. See the following in this connection:

Many applications do not allow for thermal loads during the manufacturing of electronic components and sensors. This applies in particular to applications that must have at least one of the following properties:
High mechanical elasticity
Functional layers comprised of organic components (organic semiconductors, polymers, etc.)
Temperature-sensitive substrates, such as plastic or metal with a low melting point
Prevention of material interdiffusion

Those types of properties can be found that are primarily in the area of highly-integrated circuits (ASICs, MPUs, data storage, etc.), organic electronics/sensory devices, flexible electronics/sensory devices, as well as “low cost” electronics/sensory devices. By integrating CNTs in the form of carriers or even as functional elements, significant improvements can be made in this field of application. Due to the limited temperature range (e.g. no more than approx. 200° C. for polymer-based components, no more than 400° C. for highly-integrated circuits) during the manufacturing of such components, however, a direction growth of high-quality CNTs is generally precluded due to high synthesis temperatures. In this case, only transfer methods remain for CNT integration, such as:
Deposition of CNT films in primarily horizontal CNT arrangement with drop, submersion, or spin-coating
Dielectrophoresis for the deposition of CNTs from dispersions in a primarily horizontal arrangement
Embedding of CNT layers in horizontal as well as vertical arrangement in a stabilizing matrix (polymer, epoxy resin, etc.) with subsequent transfer to another substrate

The methods are generally linked to serious disadvantages. Thus, after a transfer, it is difficult to obtain vertical CNT arrays, in which the CNTs do not agglomerate. The high surface, therefore, becomes partially void. Furthermore, they are generally subjected to chemical treatments, which influence the CNT properties, though primarily the properties of the CNT surface. Of particular difficulty is the electrical/thermal contacting of CNTs. Upon transferring CNT layers (regardless of whether vertically or branched), the difficulty contacting is particularly due to the heavy variation in the length of CNTs as well as undefined structural conditions on the ends of CNTs (e.g. shells at the ends of CNTs closed).

In contrast, the CNT coating structure of the present invention offers clear benefits when transferring CNT layers. The closed metallic surface layer on the CNT forest is in direct contact with the CNTs located below and ensures and ideal mechanical/electrical interface as well as a protective layer by the time a layer has been manufactured. Direct application of additional functional layers or supporting transfer layers and bonding agents are possible by means of various methods without interdiffusion with a the CNT layer. Thus, CNTs remain protected.

A transfer can be realized in a simple manner, in that the surface layer or the upper layer of one or more layers applied to the surface layer of the CNT coating system (which, in this case, is most frequently still on the substrate, and was used as the initial layer for manufacturing the coating system according to the invention) pursuant to the invention is put in contact with a substrate, which has bonding properties, e.g. tape, a band comprised of polydimethylsiloxane or similar or different, preferably a flexible substrate that is coated with an adhesive or bonding agent having inherently bonding properties. Upon removing this substrate, the CNTs are detached from the original or previous substrate. If a double-sided substrate is used, the coating system pursuant to the inventions can therefore be attached directly to the desired location. The now “open”, i.e. CNTs arranged without the (protective) layer, can potentially be refitted with one or more layers; alternatively, they may also exercise their function in this form, e.g. as particularly heavy absorbers (black layer).

A cost-efficient role-to-role process is also possible in order to produce CNT mats and foils on an industrial scale. Furthermore, the CNTs can be contacted extensively without additional costly processes. This provides unique possibilities for integration that provide access to a wide field of application.

According to the invention, the nanostructure of layers allows for a multitude of applications, such as those listed above. Various examples and technological approaches will be presented in the following. Application Example 1 describes the manufacturing of CNT vias. The presented structure in Application Example 2 is a new method for producing extremely dense CNT layers, which could be beneficial for many applications. Application Example 3 is a representation of the multitude of possibilities for producing even more complex nanostructures with limited technological effort. Sensory applications could benefit from this in particular. A new complex nanostructure is presented in Application Example 4. It involves a capacitor, which enables supercapacitors as a result of the three-dimensional structure. A technology is being presented for manufacturing this nanostructure with reasonable effort.

### APPLICATION EXAMPLE 1

### CNT Vias

The ICNT structure promises technological advantages with the manufacturing of vertical conductor connections (vias) particularly in complex integrated circuits (microprocessors and memory modules). Current developments in the field of CNT vias demonstrate major problems with production, severe compatibility difficulties with CMOS processes and poor electrical and thermal properties of such structures. There is still a great need for better integration technologies, which meet industrial requirements. Previous approaches to integration in CNT vias require an elaborate procedure for producing the highest contact. Contact is generally achieved by embedding CNTs with a dielectric and a CMP step, which levels irregularly grown CNTs and opens the ends of CNTs, in order to improve the electrical contact. Metallization then occurs, however, this process sequence has disadvantages. For one, a homogeneous filling must be achieved between the CNTs with a dielectric. This is technically very difficult, especially if there is a demand for a complete filling as well as high process and circuit reliability. Mechanical stress and the intrusion of wet-chemical elements in existing pores are considered to be particularly critical in the CMP step. Secondly, more complex process steps are necessary until a complete CNT via is created.

The process flow is simplified and improved with the ICNT nanostructure pursuant to the invention. In this regard, FIG. 2 shows the essential intermediate steps of a process flow based on the “single Damascene” process (Liu, R. Pai, C S, Martinez, E.: “Interconnect technology trend for microelectronics” Solid-State Electronics, vol. 43(6), pp. 1003-1009, 1999.). ICNT structures can be produced selectively in the vias through a CVD process. Selectivity can be (e.g. CMP or ion beam etching) realized by means of a “lift off” process or by means of ablative procedures. In the process, the layer comprised of structuring and catalyst material required for the growth of ICNTs is selectively applied to the bottom of said via(s). The amount of CNT is precisely set in the CVD step through the process time in such a way that the surface layer connects to the upper side of the structure in which the vias are introduced (FIG. 2a). This is followed by the deposition of a dielectric barrier and the dielectric of the metallization of the conductor plane. Subsequently, this layer is structured, wherein the metallic layer of the ICNT structure can be used as an etch stop. This is followed by the deposition of a dielectric barrier, the metallization of the conductor (e.g. with Cu), and a planarization, e.g. with a CMP step (FIG. 2b). Key advantages of this technology are the precise and uniform adjustment of the CNT height in via structures, the elimination of process steps for filling the CNT gaps with a stabilizing matrix and the CMP step as well as the usability of the CNT layer as an etch stop for a dry etching step, wherein the CNTs remain protected. A major advantage is also seen in electrical and thermal contact, for all shells of the CNTs are connected directly to the surface layer. Thus, metallization can be readily applied to the CNTs, and complex contact optimization process steps are eliminated.

### APPLICATION EXAMPLE 2

### Method for the Production of Extremely Dense CNT Films

The combination of “root” growth and ICNT growth allows for an extremely dense growth of CNTs. By using a multilayer catalyst and suitable process parameters, two CNT layers can grow into each other (FIG. 3—left). The density of the CNTs is greater than that of conventional multilayer catalysts because an intensive agglomeration of catalyst nanoparticles can be prevented in this case, wherein a large portion of the catalyst is removed through ICNT growth. A CNT layer with inter-grown CNTs can increase the density of CNTs significantly, wherefore the effective electric and thermal conductivity can be improved.

To achieve this, first a layer consisting of catalyst material is applied to said substrate or said subsurface layer in the aforementioned thickness; followed by a thermal treatment, as also stated above. This leads to the formation of catalyst nanoparticles. Respectively one layer of the structuring material and the catalytic material is applied to the resulting layer structure in the aforementioned thickness, and a second thermal treatment follows as indicated. The production of the CNTs preferably occurs in a reactor, in which the second heat treatment was carried out, again preferably chronologically immediately thereafter.

The high effective electrical and thermal conductivity produced in structures of this kind can have particular advantages in applications, such as CNT vias or thermal interface materials for efficient heat dissipation in high performance components. In the case of CNT vias, the density of said CNTs is one of the biggest challenges. With this approach, the density can be significantly increased. Moreover, additional special mechanical properties arise, such as greater rigidness of the CNT layer. Therefore, this variation can be used in surface modification of various components. Furthermore, such inter-grown CNTs can be used as nano fasteners that are useful for many new mechanical, electronic or mechanical/electronic applications.

A structure having CNTs, of which a portion grew as ICNTs, as described above, and a portion in the “root” mode is demonstrated in FIG. 4. This was achieved with a layer structure consisting of Si/SiO₂-100 nm/Ni-2.1 nm/Cr-10 nm/Ni-2.1 nm. For this purpose, after applying the initial catalyst layer (Ni), the sample was first subjected to a pretreatment at 606° C. under N₂/H₂ conditions in order to form Ni nanoparticles. Thereafter, the sample with the nanoparticle layer was coated again with Cr and then subjected to Ni. Subsequently, the sample was again subjected to a pretreatment under the conditions mentioned. Immediately thereafter, the CNT grew. The layer cross-section confirms that two different types of growth are present, originating from different locations in the sample structure. On the substrate surface (here, SiO₂) mostly unidirectional CNT growth is observed, starting from the first-applied catalyst layer. ICNT growth is also observed on the basis of Cr and a second Ni layer. The convergence of the two CNT layers can already be seen at the boundary layer. This inter-growth can be enhanced by an altered layer structure and process optimization, for inter-growth requires vertical and straight growth of CNTs on both sides. For this reason, on the substrate side, for example, the layer combination of Ta/Ni may be used. After pretreatment as described above, this leads to the formation of Ni-catalyst nanoparticles having good adhesion to the subsurface (Ta). This is a prerequisite for vertical growth of the CNTs. After this pretreatment, said Cr/Ni layers are deposited and said CNT process takes place.

### APPLICATION EXAMPLE 3

### Methods and Examples for the Production of Complex Structures and Use in Sensors

An ICNT structure allows for the formation of coating systems with additional structural elements that can impart various functionalities. Due to a closed and smooth surface layer on the CNTs, nearly any coating systems may be applied to said ICNT layer (for example, through PVD, CVD, ALD, evaporation, spin-coating) without diffusion in the CNT layer (FIG. 5a). Such coating systems can be achieved in the configuration: ICNT/Metal, ICNT/Metal/Isolator, ICNT/Isolator, etc. However, layer combinations in the form of ICNT/Metal/Graphene or ICNT/Metal/Graphite are also conceivable. Furthermore, an additional CNT layer can grow on said surface layer, which is either formed again as an ICNT or as a CNT layer with upwardly open carbon nanotubes (see FIG. 5b). In the first case, a layer consisting of structuring and catalyst material must be applied in turn on the surface layer, as described above for the production of the structure pursuant to the invention, or the surface layer must be transferred into this structure. Furthermore, the layers can be chosen freely such that CNT structures, as based on the state of the art, can grow thereon. Thus, for example, an additional contact layer (e.g. Ta) may be applied to said ICNT layer or a present coating system. After the deposition of a catalyst (e.g. Ni, Co, Fe), an additional layer comprising vertical CNTs can be obtained by means of a second CVD process. FIG. 5c depicts such a multilayer CNT structure, wherein a coating system consisting of SiO₂Ta/Ni was applied said ICNT layer and then exposed to a second CVD process. This resulted in an additional layer of vertically aligned CNTs.

Such developed coating systems enable a wide variety of applications. A structure, such as illustrated in FIG. 5a, may be used for flip chip connections, sensors, and actuators in addition to the CNT via application. The possibility of applying CNTs for flip chip applications has already been demonstrated, see Hermann, S.; Pahl, B.; corner, R. Schulz, S E, Gessner, T.: “Carbon nanotubes for nano-scale low temperature flip chip connections “Microelectronic Engineering, vol. 87 (3), pp. 438-442, 2010.

Electrical properties can be significantly improved with said ICNT structure due to the fact that a form-fit electrical contact with a highly elastic layer, which is metallized in the contact zone, can be obtained.

With regard to the sensors, for example, a pressure sensor can be realized easily. For this embodiment, a substrate layer such as SiO₂ is provided on the layer structure of the catalyst system is applied. This serves as a sacrificial layer, and is etched after formation of the CNTs at least partially. There are two possible variants:
A) With the help of the ICNT layer, a capacitor can be created with a unilaterally flexible diaphragm. Said ICNT layer is initially produced on a substrate with integrated metallization. Subsequently, the fields of said ICNT layer are introduced in frames through structuring, embedding, and metallization steps. In conclusion, the CNTs are removed through the use of plasma-activated O₂. As a result, gap distances can generally be set as desired through the duration of the CVD process (e.g. 1 to 5000 nm). The application of pressure causes a change in gap between the substrate, into which an insulated electrode is integrated, and the ICNT layer. This deflection is detected through a change in capacity. CNT-free gaps with an extremely small gap width can also be produced on the basis of such a structure. This type of model offers technological advantages due to the fact that gaps can be produced on larger areas as well.
B) A field emission may also be used to achieve a highly sensitive detection of deformations and movements (FIG. 6). In this regard, said ICNT structure offers special technological benefits. Using sacrificial layers, very small gap distances can be precisely adjusted for said field emission. Due to the small gaps distances, the structure can be operated at a low voltage. One possible process flow provides for the embedding of a pre-structured ICNT structure. The embedding can be done using CVD or PVD. The membrane (ICNT layer) is then partially exposed through etching, followed by the application of the upper metallization. Subsequently, a sacrificial layer is removed below the CNTs. Voltage is applied between the bottom of the CNTs and the lower electrode, which causes a field emission. Deformation of the membrane can be accurately detected by a change of current. The tunnel effect can also be used for very small gap distances (<10 nm), which leads to an even higher sensitivity. Such a structure can be used for detecting deformation and pressures. In this manner, for example, nano-microphones with an extended frequency range and small size can be achieved.

Actuators can also be achieved with a capacitor structure. Electrode arrays embedded in the substrate can lead to a deflection of the ICNT surface layer. Deformable reflectors, for example, can be achieved in connection with the particularly smooth surface of the ICNT layer. This could be used in applications such as projectors or nanopositioning.

The structure presented in FIG. 6 can also be used as a starting point for the construction of an adjustable interferometer. In this case, the CNTs are only of use for setting a certain gap distance. After embedding, the CNTs are removed through oxygen plasma (remote plasma). What is left is a thin membrane with a thickness of approx. 10 nm, which is sufficiently transparent in the visible spectral range. This membrane can potentially be extended by additional optical and stabilizing layers (see FIG. 8). A gap is obtained in this manner together with a reflective layer on the part of the substrate, wherein an interference condition is achieved for certain wavelengths and angles of incidence. The interference condition can be adjusted by applying a voltage between said substrate and membrane, through which a variable interference filter emerges.

### APPLICATION EXAMPLE 4

### Production of a Supercapacitor on the Basis of Carbon Nanotubes

Based on the structure presented in FIG. 5b and c, a new superstructure can be produced using the ICNT structure, which can be used as a supercapacitor (FIG. 7). This type of structure is based on a combination of two approaches. First, the production process pursuant to the invention for coiled microtubes should be applied. In this case, the coiling of a layer is caused by a tensioned coating system that delaminates after exposure (see Prinz, V. Y.; Seleznev, V. A.; Gutakovsky, A. K.; Chehovskiy, A. V.; Preobrazhenskii, V. V.; Putyato, M. A.; Gavrilova, T. A.: “Free-standing and overgrown InGaAs/GaAs nanotubes, nanohelices and their arrays” Physica E: Low-dimensional Systems and Nanostructures, vol. 6(1-4), pp. 828-831, 2000; Schmidt, O. G. and Eberl, K.: “Nanotechnology: Thin solid films roll up into nanotubes” Nature, vol. 410(6825), pp. 168-168, 20 01). This is achieved, for example, with InAs/GaAs two-layer systems, which are braced due to different lattice constants and coil after removal of a sacrificial layer. Secondly, the ICNT structure presented here forms a basic requirement.

According to the invention, manufacturing of the structure begins with the production of an ICNT film having vertical and straight CNTs on an insulating substrate. Then a coating system is applied. The coating system is selected in consideration for the state of the art, e.g. the above article by Prince et al. in such a way that a tensioning of the surface layer is achieved. Two metallization layers located in this coating system are separated by an insulating layer. The lower metallization is in direct electrical contact with the ICNT layer. The upper metal layer contacts the next following second CNT layer. The upper CNT layer is produced with a standard method for producing vertically aligned CNTs (similar to that depicted FIG. 5b). In order to improve a telescoping of the CNTs during the subsequent coiling of the coating system, the CNT density of the uppermost CNT layer can be controlled through the film thickness of the catalyst, pretreatment of the catalyst layer, pre-structuring of the substrate and/or of the layer composition. Due to the fact that the initially uppermost and then inner CNT layer is structurally compressed upon coiling up, the density of the CNTs should be slightly lower than that of the CNTs in the ICNT layer. This is achieved, for example, through a structuring of the catalyst, as known from the state of the art. Structuring can be achieved through conventional lithography or electron beam exposure. The catalyst can be structured with the lift-off or etching process.

Subsequently, a dielectric (e.g. Al₂O₃, HfO, etc.) is homogeneously applied to the upper layer of the CNT using the ALD method on CNT surface, to prevent direct electrical contact between the two telescoping CNT layers and also to increase the capacitance of the capacitor. In conclusion, the tensioned coating system is relaxed through lateral exposure, and the structure begins to coil as shown in FIG. 7. Exposure can be achieved through various methods, such as FIB (focused ion beam), dry etching (after embedding with a protective layer), or blasting structures. The lower and upper sides are compressed into each other when coiling. A capacitor is formed through mutual electrical contact and the dielectric between both CNT layers. Due to the high aspect ratio of the CNTs, this capacitor has a significantly higher capacitance than other coiled microtubes that only use the surface of the opposite plate. Thus, the production of a supercapacitor is enabled, which can be used in a variety of applications in electronics supply. Particularly promising is a solution of this kind for self-sufficient and energy-efficient for nanoelectronic systems. This enables the power supply of electronics, sensors and actuators in a very small space, which, for example, could be of great interest for biological applications that increasingly use microstructure elements.

### PRODUCTION EXAMPLE 1

A layer consisting of 100 nm of SiO₂ (surface roughness RMS=0.2 nm) was formed through thermal oxidation on a silicon wafer as a substrate. This was followed by a sputter deposition of a 7 nm thick chromium layer and a 2.1 nm thick nickel layer with interruption in air. The target unit in each case was 99.99% and the substrate was at room temperature during the deposition. The roughness of the surface was determined to be 0.4 nm (RMS). A thermal treatment (pretreatment) followed in an N₂/H₂ (5:1) atmosphere at 700 mbar and 606° C. for 10 min. A catalyst layer having a layer of chromium with folds or recesses emerged as a result, between which particles from the catalyst material were located. After the pretreatment of the sample, the ICNT layer was produced in the same reactor. This was carried out at 606° C. in an N₂/H₂/C₂H₄=443/100/15 sccm gas atmosphere at 200 mbar. In this process, C₂H₄ served as the carbon source. The duration of this stage of the process was varied in the range 3 min. to 20 min. A 10-minute process produced a layer of cross-sections as depicted in FIG. 1a. The carbon nanotubes forming in this case grew in “tip” mode below the structured, catalyst-containing layer such that a closed surface layer from both metals was subsequently located on the CNT layer. The thickness of the surface layer was able to be estimated at approx. 10 nm. The outer and inner diameter of MWCNTs was 21 nm and 7 nm; the density of the CNTs was able to be determined at 1.9×10¹⁰ cm². The growth rate was found to be 395 nm/min.

### PRODUCTION EXAMPLE 2

The same process conditions as in Example 1 were also applied to the coating system Si/SiO₂ (100 nm)/Cr (10 nm)/Co (2.1 nm). Under these conditions, an ICNT layer was also achieved, but with a CNT growth rate lower than Cr/Ni (100 nm/min).

### PRODUCTION EXAMPLE 3

Production according to this example varies from that in Example 1, in that said catalyst is initially applied as a layer and then the structuring layer. The step sequence can be specified as follows:
1. Deposition of Ni (or Co) (1.5 to 3 nm) with PVD (e.g. EBD or sputtered) on SiO₂ (100 nm)
2. Transformation of Ni (or Co) layer in nanoparticles through tempering in N₂ or N₂/H₂-atmosphere (700 mbar) at 400-800° C. (preferably approx. 600° C.)
3. Deposition of Cr (5 to 15 nm) with PVD (e.g. EBD or sputtered)
4. CNT synthesis with CVD process with, e.g. N₂/C₂H₄/H₂=500/25/100 sccm at 200 mbar and 400-800° C. (preferably approx. 600° C.)

The second step can potentially be eliminated if the Ni deposition was produced or if Ni (or Co) were deposited as a nanoparticle (e.g. from dispersion, acetate solution or physically with particle generators+particle beam).

### COMPARATIVE EXAMPLE

A reference sample had the structure Si/SiO₂(100 nm)/Ta (10 nm)/Ni (2.1 nm); it was treated with the same process as the sample for ICNT growth. Accordingly, the reference sample was subject to the same process conditions with the catalyst thickness, pretreatment and CNT growth conditions.

A 30% improvement of the quality of the ICNT layer compared to the reference layer was observed. The best value was at 606° C., N₂/H₂C₂H₄=443/100/15 sccm and 200 mbar.

Thus, in summary the invention provides the following subjects, methods and uses:
A. A coating system, comprising a layer of carbon nanotubes aligned parallel to another, and a surface layer directly associated with metallic properties.
B. A coating system according to item A, wherein a surface layer has chromium in combination with cobalt and/or contains or consists of nickel.
C. A coating system according to any one of the preceding points, wherein said layer of carbon nanotubes has a thickness between 1 and 5000 nm and/or said surface layer has a thickness of 4 to 20 nm
D. A coating system according to any one of the previous points having a density of the carbon nanotubes in the range of 5×10⁹ to 5×10¹²/cm².
E. A coating system according to any one of the previous items, further comprising a base layer and/or a substrate.
F. A coating system according to item D, wherein said base layer or said substrate are dielectric.
G. A coating system according to point E or F having a substrate consisting of silicon and/or a base layer consisting of SiO₂.
H. A coating system according to item D, wherein said base layer or said substrate is electrically conductive and preferably has metallic properties.
I. A coating system according to point H, wherein said base layer consisting of TiN, TaN, Ti, Ta, Pd or W is formed.
J. A coating system according to one of the points E or I, wherein said substrate has one or more recesses and the layer of parallel aligned carbon nanotubes, and the surface layer having metallic properties in the recess or recesses are located, wherein the upper surface of the surface layer, where there are no recesses and preferably connects to the top of the substrate.
K. A coating system according to item Y, wherein the recess(es) have the form of vias.
L. A coating system according to one of the points J or K, further comprising a conductive plane in the substrate and/or a structured dielectric barrier and a structured metallization layer above the coating system in such a way that electrical contacting of the recesses or vias can be made.
M. A coating system according to one of the points E to L, wherein the layer of carbon nanotubes aligned parallel to another further comprises carbon nanotubes, which are located between said initially-mentioned carbon nanotubes and have increased relative to those in the opposite direction.
N. A coating system according to item M, wherein the number of carbon nanotubes aligned in the opposite direction per unit area is 50 to 100% of the number of carbon nanotubes aligned parallel to another on said surface unit.
O. A coating system according to item M or N, comprising a bonding layer arranged on the substrate or the base layer.
P. A coating system according to point O, wherein cobalt or nickel were used as a catalyst for growing carbon material in the opposite direction thereof and/or wherein the bonding layer is tantalum and wherein the base layer consists of SiO₂ or is not present.
Q. A coating system according to any one of the preceding items, further comprising one or more layer(s) applied to the surface layer.
R. A coating system according to item Q, wherein one of the layers applied to the surface layer is a second layer of carbon nanotubes aligned parallel to another.
S. A coating system according to item R, wherein there is a dielectric or a metallic layer on the second layer of carbon nanotubes.
T. Use of a coating system according to one of the points Q to S in or for the manufacturing of electronic nanosystems, flip chip connections, sensors, or act(ua)ors, in particular pressure sensors, contact sensors, optical sensors, mirrors, projectors, optical filters, nanopositioners or interferometers.
U Use according to point T, wherein said coating system comprises a base layer in the form of a sacrificial layer that is removed in the course of manufacturing.
V. Use according to point T, wherein the layer of carbon nanotubes aligned parallel to another serves as a sacrificial layer that is removed in the course of manufacture.
W. A coating system according to the point Q with an electrically insulating sacrificial layer as a base layer, wherein the layers applied to the surface layer form a layer structure, having a bias voltage, wherein said layer structure comprises two metallic layers, which are separated by an insulating layer and the lower of the two metallic layers is in direct electrical contact with the parallel aligned carbon nanotubes is, further comprising a second layer of parallel aligned carbon nanotubes, which is located on the upper of the two metal layers and is in direct contact therewith, wherein the carbon nanotubes of the second layer of are covered by a dielectric layer.
X. A coating system according to point W with remote sacrificial layer in a coiled form.
Y. Using a coating system according to point X as a supercapacitor.
Z′. Method for producing a coating system according to any one of the preceding points, comprising the following steps:
   (1) Providing a substrate potentially with a base layer,
   (2) Forming a structured layer from a first phase consisting of a metal not having independent catalytic activity for the emergence of CNTs from the gas phase and a second phase consisting of a metal, which catalyses the formation of CNTs from the gas phase, wherein the first phase has a non-uniform thickness and/or folded structure, which is potentially interspersed with pores, and the second phase is found in recesses and/or pores of the first phase such that both material phases are present in the lateral plane at least partially next to each other, on the substrate or the thereon base layer, (3) deposition of carbon from a hydrocarbon-containing gas atmosphere, wherein carbon nanotubes form at least parts of the lifting of the structured layer in closed form.
   (3) Deposition of carbon from a hydrocarbon-containing gas atmosphere, wherein carbon nanotubes are form, which lift at least parts of the structured layer in closed form.
Z″. Method according to item Y, wherein the generation of the structured layer takes place by applying a first layer of the first phase to the substrate or base layer, and then applying a second layer of the second phase, whereupon the resulting stacked layer is exposed to a temperature preferably above 400° C., preferably in a reducing gas atmosphere.

What is claimed is:

1. Layer system, comprising a layer made of carbon nanotubes aligned parallel to one another and a metallic top layer directly connected thereto, comprising chromium, molybdenum, or an alloy made from it or with it.

2. Layer system according to claim 1, wherein particles made of metal are embedded or alloyed in the top layer, wherein the metal catalyzes the production of carbon tubes from the gas phase.

3. Layer system according to claim 2, wherein the particles that catalyze the production of carbon nanotubes from the gas phase are selected from among cobalt, nickel, iron, or an alloy of these materials.

4. Layer system according to claim 3, wherein the top layer contains chrome in combination with cobalt and/or nickel.

5. Layer system according to claim 1, further comprising a base layer or a substrate.

6. Layer system according to claim 5, wherein the base layer is dielectric, and in particular consists of SiO₂, or wherein the substrate is dielectric or consists of silicon.

7. Layer system according to claim 5, wherein the base layer or the substrate is electrically conductive, and preferably has metallic properties, wherein the base layer is preferably made of TiN, TaN, Ti, Ta, Pd or W.

8. Layer system according to claim 5, wherein the substrate has one or more recesses, in particular in the form of vias, and the layer made of carbon nanotubes aligned parallel to one another and the metallic layer are located in the recesses, wherein the upper side of the top layer, where there are no recesses, is preferably joined to the upper side of the substrate.

9. Layer system according to claim 8, further comprising a conductive layer in the substrate or a structured dielectric barrier and a structured metallization layer above the layer system, in such a way that an electrical connection can take place through the recesses or the vias.

10. Layer system according to claim 5, wherein the layer made of carbon tubes aligned parallel to one another has additional carbon tubes, which are located between the carbon tubes, and have grown relative to these in the opposite direction.

11. Layer system according to claim 10, comprising an adhesive layer that is located on the substrate or the base layer, wherein the adhesive layer is preferably made of tantalum.

12. Layer system according to claim 10, wherein cobalt or nickel was used as a catalyst for the carbon tubes that have grown in the opposite direction, or wherein the base layer consists of SiO₂ or does not exist.

13. Layer system according to claim 1, further comprising one or more layers applied on the top layer.

14. Layer system according to claim 13, wherein one of the layers applied on the top layer is a second layer made of carbon nanotubes aligned parallel to one another.

15. Use of a layer system according to claim 1 in or for the manufacturing of a device, preferably selected among electronic nanosystems, electronic components, flip-chip connections, sensors, or actuators, in particular among pressure sensors, contact sensors, humidity sensors, optical sensors, mirrors, projectors, optical filters, nanopositioning systems, light-emitting diodes and displays, each of which are preferably flexible, interferometers, or the use of such layer system as a black absorption layer.

16. Use according to claim 15, wherein the layer system has a base layer in the form of a sacrificial layer, which is removed in the course of production.

17. Use according to claim 15, wherein the layer made of carbon nanotubes aligned parallel to one another serves as a sacrificial layer, which is removed in the course of production.

18. Use according to claim 15, wherein the layer system is transferred to an adhesive layer of a carrier that is preferably flexible, and wherein this carrier is or will be or has been subsequently installed in the device.

19. Layer system according to claim 13 with an electrically insulating sacrificial layer as a base layer, wherein the layers applied on the top layer form a layer structure, which has an initial tension, wherein the layer structure comprises two metallic layers, which are separated by art insulation layer, and wherein the lower one of the two metallic layers is in direct electrical contact with the carbon tubes aligned parallel to one another, further comprising a second layer of carbon tubes aligned parallel to one another, which is located on the upper one of the two metallic layers and which is in direct contact with it, wherein the carbon tubes of the second layer are covered by a dielectric layer.

20. Layer system according to claim 19 with a removed sacrificial layer in a coiled form.

21. Use of as layer system according to claim 19 as a supercapacitor.

22. Method for producing a layer system according to claim 1, comprising the following steps:
(1) Provision of a substrate, if applicable with a base layer;
(2) Production of a structured layer from a first phase, which consists of a metal that has no independent catalytic activity with respect to the production of CNTs from the gas phase, wherein the metal is chromium, molybdenum, or an alloy made of or with one of these metals, along with a second phase made of a metal that catalyzes the production of CNTs from the gas phase, selected from among cobalt, nickel, iron, and alloys of these materials, wherein the first phase has a structure that is unevenly thick or folded and optionally interspersed with pores, and wherein the second phase is located in recesses or pores of the first phase in such a way that the two material phases in the lateral level are at least partially adjacent to one another, on the substrate or the base layer located on the substrate; and
(3) Removal of carbon from a gas atmosphere containing hydrocarbons, wherein carbon nanotubes form, which raise at least parts of the structured layer in a closed form.

23. Method according to claim 22, wherein the production of a structured layer takes place in such a way that a first layer from the first phase and, thereupon, a second layer from the second phase, is applied on the substrate or the base layer, whereupon the stack layer that has formed is exposed to a temperature of preferably over 400° C., preferably in a reducing gas atmosphere.

24. Method according to claim 22, wherein the production of the structured layer takes place by providing that nanoparticles of the second phase are provided on the substrate or the base layer, whereupon a layer of the first phase is applied, and subsequently the stack layer that has formed is exposed to a temperature of preferably over 400° C., preferably in a reducing gas atmosphere.

25. Method according to claim 24, wherein the nanoparticles of the second phase are applied already in the form of particles on the substrate or the base layer, or wherein the nanoparticles of the second phase are produced by preparing a layer of the material of the second phase, and subsequently transferring same into nanoparticles.
